(19) United States
(12) Patent Application Publication
(10) Pub. No.: US 2025/0207982 A1
(43) Pub. Date: Jun. 26, 2025

(54) Thermal Interface Circuit

(71) Applicant: Therm-O-Disc, Incorporated, Westerville, OH (US)

(72) Inventors: Nathaniel Zachariah GRIEST, Rockford, MI (US); Amy Jo HERTEL, Muskegon, MI (US); Joshua Charles WHEELER, Muskegon, MI (US)

(73) Assignee: Therm-O-Disc, Incorporated, Westerville, OH (US)

(21) Appl. No.: 18/974,964

(22) Filed: Dec. 10, 2024

Related U.S. Application Data
(60) Provisional application No. 63/614,063, filed on Dec. 22, 2023.

(51) Int. Cl. G01K 7/14; G01K 1/024; G01K 7/02

(52) U.S. Cl. CPC G01K 7/14; G01K 1/024; G01K 7/023

(57) ABSTRACT

A thermal interface circuit and a method for operating the same includes a controller, a thermocouple and a thermocouple signal conditioner coupled to the controller using two wires comprising a voltage input and a ground. The controller provides a first voltage to the signal conditioner. The signal conditioner receives a voltage from the thermocouple and generates a conditioned voltage corresponding to the voltage from the thermocouple. The signal conditioner reduces the first voltage by the conditioned voltage to form a sensing voltage. The controller determines a temperature output signal at the controller based on the sensing voltage.

### CROSS-REFERENCE TO RELATED APPLICATIONS

This application claims the benefit of U.S. Provisional Application No. 63/614,063, filed on Dec. 22, 2023. The entire disclosure of the above application is incorporated herein by reference.

### FIELD

The present disclosure relates to thermal sensing, and, more specifically, to a circuit and method for a conditioned, analog thermocouple output suitable for communication with a controller.

### BACKGROUND

This section provides background information related to the present disclosure which is not necessarily prior art.

Temperature sensors are used in many industries and in many products. Depending on the sensing requirements and the instruments used, different types of temperature sensors may be used. Each type of temperature sensor has different characteristics.

Resistance temperature detectors (RTDs) are one type of temperature sensor. RTDs provide analog voltage inputs to a control unit. The resistance of the RTD changes with temperature, which changes the drop in voltage across the sensor. This voltage change, given a fixed input voltage, is used by the control unit to determine the temperature. However, environments in which they are used have become more extreme, characterized by high temperature and larger forces.

To use an RTD a controller such as an electronic control unit (ECU) sends a voltage to the Resistance Temperature Detector (RTD). In many systems the voltage is 5 volts. The RTD changes resistance with temperature and changes the voltage to less than 5 volts. The controller reads the new voltage and generates an output temperature that correlates.

Thermocouples are more physically robust and are more reliable in high temperature environments. Further, thermocouples have a higher temperature range and faster response time than RTDs. In contrast, thermocouples provide a voltage output instead of a resistance change. In use, the thermocouple sends voltage to signal conditioner that is less than 1 volt. The signal conditioner transforms the thermocouple voltage into a digital signal. The signal conditioner or other electronics sends digital signal to the controller. The controller then reads in a digital signal and outputs a temperature signal that correlates.

### SUMMARY

This section provides a general summary of the disclosure and is not a comprehensive disclosure of its full scope or all of its features.

The present circuit, referenced as “signal conditioner” or “SC” below or in referenced figures, provides a conditioned voltage output, which is then combined with a second “source” voltage from a controller to create a new “expected voltage.” The controller uses the new expected voltage to determine the temperature.

The two-wire (voltage input and ground) analog output allows use with traditional sensor systems, similar to RTD, and contrary to other digital temperature sensors (DTS), since the signal conditioner power does not require an additional wire for power.

The thermocouple gives greater robustness and accuracy at higher temperatures compared to an RTD and similar to a DTC.

More specifically, a method includes connecting a thermocouple signal conditioner to a controller using two wires comprising a voltage input and a ground, receiving a first voltage from the controller into a signal conditioner, receiving a voltage, generated from a thermocouple, at the signal conditioner, generating a conditioned voltage corresponding to the voltage from the thermocouple, reducing the first voltage by the conditioned voltage to form a sensing voltage and determining a temperature output signal at the controller based on the sensing voltage.

In another aspect of the disclosure, a thermal interface circuit includes a controller, a thermocouple and a thermocouple signal conditioner coupled to the controller using two wires comprising a voltage input and a ground. The controller provides a first voltage to the signal conditioner. The signal conditioner receives a voltage from the thermocouple and generates a conditioned voltage corresponding to the voltage from the thermocouple. The signal conditioner reduces the first voltage by the conditioned voltage to form a sensing voltage. The controller determines a temperature output signal at the controller based on the sensing voltage.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a simplified block diagrammatic view of a vehicle having temperature sensing.

FIG. 2 is a circuit board having a signal conditioning circuit thereon connected to a hypothetical ECU system.

FIG. 3 is a simplified flowchart of a method for operating the system.

Corresponding reference numerals indicate corresponding parts throughout the several views of the drawings.

### DETAILED DESCRIPTION

Example embodiments will now be described more fully with reference to the accompanying drawings.

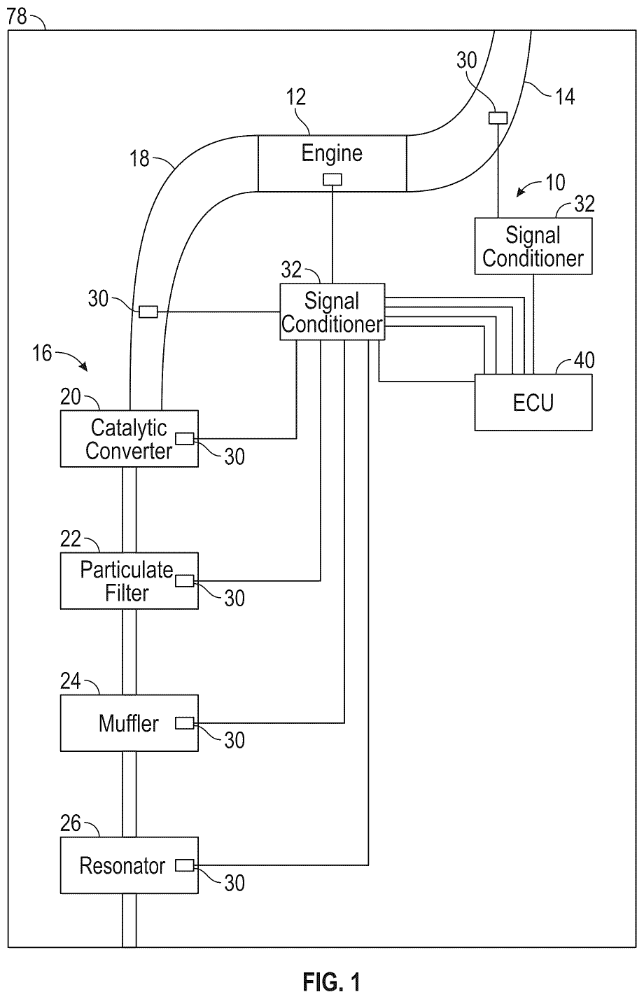

Referring now to FIG. 1, a simplified vehicle 8 is illustrated having a thermal interface circuit 10. The vehicle 8 has an engine 12. The engine 12 has an air intake 14, an exhaust system 16 having an exhaust manifold 18. The exhaust system 16 has a plurality of heat emitting component such as catalytic converter 20, an optional particulate filter 22 typically used in diesel vehicles, a muffler 24 and a resonator 26. Each of the components above may use one of more thermocouples 30 coupled to a signal conditioner 32 which in turn is coupled to a controller 40 such as an electronic control unit 40 (ECU). One signal conditioner 32 may be provided for each thermocouple. The controller 40 and the signal conditioner are configured to perform various steps as described below. However, signal conditioner 32 may be combined to form a signal interface. The signal conditioner 32 may be an integrated circuit. One example of which is a

The use of the system in automotive application is provided as an example of one of the many uses in various system in various industries.

In general, the thermal interface circuit uses series opposing sources, which is a second voltage with opposite polarity that is subtracted from a first voltage. The thermocouple TC outputs a variable voltage V_{TC} based on temperature. The signal conditioner (SC) converts the thermocouple (TC) to another voltage, Vout. The signal conditioner 32 outputs an absolute voltage V_{OUT}. The ECU initially supplies a voltage, V_{ECU} to the signal conditioner 32. The output of the ECU, V_{ECU}, has the output voltage Vout from the signal conditioner subtracted therefrom. The ECU checks for change in this voltage, which has to stay at or above a certain voltage to power the signal conditioner. The minimum voltage powering the SC is therefore V_{ECU}-V_{out,max}=V_{pow}. The SC output is used to change the first voltage powering the SC without disabling the SC due to lower power. That is, the signal conditioner 32 remains powered since the new voltage meets the designed power requirement.

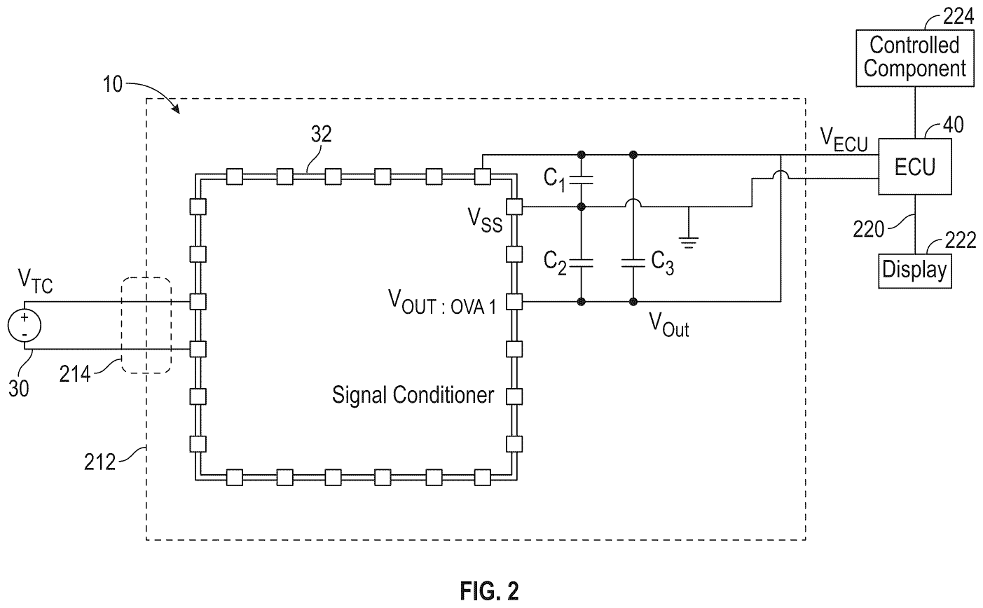

Referring now to FIG. 2, the thermal interface circuit 10 that may be formed on a printed circuit board assembly 212 is set forth. Connector 214 is coupled to a thermocouple 30. The connector 214 is a two-wire connector through which the voltage is received at the signal conditioner 32. More than one connector 214 and more than one thermocouple 30 may be used in the circuit 10. The circuit 10 has an analog output, along with the benefits of a thermocouple like greater temperature range, faster response time, more robust construction and higher accuracy. The power to the signal conditioner is “V_{ECU}” and may be about 5 volts or between 2.7 Volts and 5.5 volts. The voltage Vₒᵤₜ is the expected voltage corresponding to the thermocouple voltage and may be between 0 volts and 1 volt. The voltage Vₒᵤₜ opposes V_{ECU} reducing V_{ECU}. The reduced voltage corresponds to the thermocouple voltage and is read by the ECU to determine an associated temperature corresponding to the reduced voltage. The reduced voltage is within the operating voltage of the input to the signal conditioner 32 such as 2.7 and 5.5 volts. However, in this example the reduced voltage is not below 4 volts. The temperature determined by the controller 40 may be communicated through a network 220 or directly communicated to a display 222 that is used for displaying a temperature. The controller 40 may control the operation of a controlled component 224. The controlled component 224 could be an actuator, engine controller, heater controller, process controller or the like. The system may include capacitors C1, C2, C3 for noise isolation and the like. In this example, C1 is coupled between the input voltage of the signal conditioner and Vₛₛ (ground) of the signal conditioner. C2 is coupled between Vₛₛ and Vout of the signal conditioner. C3 is disposed between the V_{ECU} and Vₒᵤₜ.

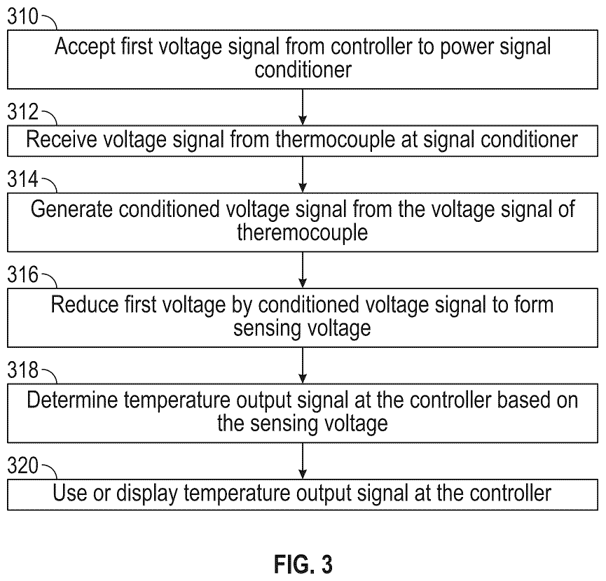

Referring now to FIG. 3, a method of operating a temperature determination system is set forth. A thermocouple signal conditioner is connected to a controller system using two wires having a voltage input and a ground. In step 310, a first voltage from a controller to a signal conditioner is provided. In step 312, a temperature signal (voltage) from a thermocouple is received at the signal conditioner through a two-wire connector. A conditioned voltage signal corresponding to the temperature signal at the thermocouple is generated in the signal conditioner in step 314. In step 316 the first voltage is reduced by the conditioned voltage signal to form a sensing voltage. The conditioned voltage signal may be referred to as an opposing voltage signal which reduced the voltage provided by the ECU. A temperature output signal is determined at the controller based on the sensing voltage in step 318. In step 320 the temperature output signal is used to control another component associated with the controller or may be displayed on a display.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.” The term subset does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the Illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “System C”), that encompasses both code, as described below, and hardware description.

The term “code” or “instructions,” as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term “storage medium” or memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (I) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCamI, Javascript®, HTMLS (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic@, Lua, MATLAB, SIMULINK, and Python@.

What is claimed is:

1. A method comprising:
connecting a thermocouple signal conditioner to a controller using two wires comprising a voltage input and a ground;
receiving a first voltage from the controller into a signal conditioner;
receiving a voltage, generated from a thermocouple, at the signal conditioner;
generating a conditioned voltage corresponding to the voltage from the thermocouple;
reducing the first voltage by the conditioned voltage to form a sensing voltage; and
determining a temperature output signal at the controller based on the sensing voltage.

2. The method of claim 1 wherein receiving the voltage comprise receiving the voltage though a connector.

3. The method of claim 1 wherein receiving the voltage comprise receiving the voltage though a two-wire connector.

4. The method of claim 1 wherein generating the conditioned voltage comprises generating the conditioned voltage between 0 volts and 1 volt.

5. The method of claim 1 wherein reducing the first voltage to form the sensing voltage comprises reducing the first voltage to form the sensing voltage of between 2.7 volts and 5 volts.

6. The method of claim 1 further comprising displaying a temperature corresponding to the temperature output signal on a display.

7. The method of claim 6 wherein prior to displaying communicating the temperature to the display.

8. The method of claim 1 further comprising controlling a controlled component in response to the sensing voltage.

9. The method of claim 1 further comprising coupling the thermocouple to a heat emitting component.

10. The method of claim 1 further comprising coupling thermocouples coupled to a plurality of heating emitting components and to the signal conditioner.

11. A system comprising:
a controller;
a thermocouple;
a thermocouple signal conditioner coupled to the controller using two wires comprising a voltage input and a ground;
said controller providing a first voltage to the signal conditioner;
the signal conditioner receiving a voltage from the thermocouple and generating a conditioned voltage corresponding to the voltage from the thermocouple, the signal conditioner reducing the first voltage by the conditioned voltage to form a sensing voltage; and
the controller determining a temperature output signal at the controller based on the sensing voltage.

12. The system of claim 11 further comprising a connector coupling the thermocouple and the signal conditioner.

13. The system of claim 11 further comprising a two-wire connector coupling the thermocouple and the signal conditioner.

14. The system of claim 11 wherein the conditioned voltage is between 0 volts and 1 volt.

15. The system of claim 11 wherein reducing the sensing voltage is between 2.7 volts and 5 volts.

16. The system of claim 11 further comprising a display displaying a temperature corresponding to the temperature output signal.

17. The system of claim 16 wherein the controller communicates the temperature to the display.

18. The system of claim 11 further comprising a controlled component controlled by the controller in response to the sensing voltage.

19. The system of claim 11 further comprising a heat emitting component coupled to the thermocouple.

20. The system of claim 11 further comprising a plurality of thermocouples coupled to heat emitting components and to the signal conditioner.
